(19) United States
(12) Patent Application Publication
(10) Pub. No.: US 2026/0048438 A1
(43) Pub. Date: Feb. 19, 2026

(54) METHODS OF FORMING THREE-DIMENSIONAL STRUCTURES BY ADDITIVE MANUFACTURING

(71) Applicant: Battelle Energy Alliance, LLC, Idaho Falls, ID (US)

(72) Inventors: Prabhat K. Tripathy, Idaho Falls, ID (US); Michael R. Shaltry, Idaho Falls, ID (US); Kiyo Tiffany Fujimoto, Meridian, ID (US)

(21) Appl. No.: 19/299,976

(22) Filed: Aug. 14, 2025

Related U.S. Application Data
(60) Provisional application No. 63/683,541, filed on Aug. 15, 2024.

(51) Int. Cl. B22F 10/43; B33Y 10/00

(52) U.S. Cl. CPC B22F 10/43; B22F 2201/01; B22F 2201/10; B33Y 10/00

(57) ABSTRACT

A method of forming a three-dimensional structure comprises forming a layer of a precursor material on a substrate using an additive manufacturing process, the precursor material comprising one or more of a metal oxide, a metal sub-oxide, a metal carbide, a metal nitride, a metal boride, a metal hydride, a metal silicide, a metal salt, and a pre-ceramic polymer; forming one or more additional layers of the precursor material on the layer of the precursor material; and exposing the layers of precursor material to an energy source to reduce the precursor material to form a three-dimensional structure comprising an elemental metal, a metal alloy, a ceramic, or a composite.

### CROSS-REFERENCE TO RELATED APPLICATIONS

This application claims the benefit under 35 U.S.C. § 119(e) of U.S. Provisional Patent Application Ser. No. 63/683,541, filed Aug. 15, 2024, the disclosure of which is hereby incorporated herein in its entirety by this reference.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

Embodiments of the disclosure relate generally to forming three-dimensional structures utilizing additive manufacturing. More particularly, embodiments of the disclosure relate to methods of forming the three-dimensional structures under reducing conditions.

### BACKGROUND

Metallic materials are widely used in multiple industrial sectors. Conventional production of metallic materials includes two principal unit operations: reduction of a metal compound and refining of the as-reduced metal. Conventional processing and/or manufacturing methods may require multiple, complex steps. Metal feedstock materials for conventional manufacturing methods often exhibit a limited shelf-life due to their sensitivity towards oxygen and moistened air. For example, metal feedstock materials often undergo unwanted oxidation reactions which may result in the metal feedstock materials having reduced functionality. In addition, the costs of the metal feedstock material are usually high.

### BRIEF SUMMARY

A method of forming a three-dimensional structure is disclosed. The method comprises forming a layer of a precursor material on a substrate using an additive manufacturing process, the precursor material comprising one or more of a metal oxide, a metal sub-oxide, a metal carbide, a metal nitride, a metal boride, a metal hydride, a metal silicide, a metal salt, and a pre-ceramic polymer. The method includes forming one or more additional layers of the precursor material on the layer of the precursor material. The layers of precursor material are exposed to an energy source to reduce the precursor material to form a three-dimensional structure comprising an elemental metal, a metal alloy, a ceramic, or a composite.

Also disclosed is a method of forming a three-dimensional structure comprising forming a layer of a precursor material on a substrate using an additive manufacturing process, the precursor material comprising one or more of a metal oxide, a metal sub-oxide, a metal carbide, a metal nitride, a metal boride, a metal hydride, a metal silicide, a metal salt, and a pre-ceramic polymer and one or more reducing agents, and forming one or more additional layers of the precursor material on the layer of the precursor material. The layers of precursor material are exposed to an energy source to reduce the precursor material to form a three-dimensional structure comprising elemental metal, a metal alloy, a ceramic, or a composite.

Also disclosed is a method of forming a three-dimensional structure comprising forming one or more layers of a stoichiometric metal oxide on a substrate under reducing conditions using an additive manufacturing process to form one or more layers of a non-stoichiometric metal oxide on the substrate. The one or more layers of non-stoichiometric metal oxide are exposed to an energy source to reduce the non-stoichiometric metal oxide to form a three-dimensional structure comprising elemental metal or a metal alloy.

### BRIEF DESCRIPTION OF THE DRAWING

For a detailed understanding of the disclosure, reference should be made to the following detailed description, taken in conjunction with the accompanying drawing, in which like elements have generally been designated with like numerals, and wherein:

FIG. 1 is a flow diagram of a method of forming a three-dimensional structure in accordance with embodiments of the disclosure.

FIG. 2 is a flow diagram of a method of forming a three-dimensional structure in accordance with embodiments of the disclosure.

### DETAILED DESCRIPTION

The illustrations presented herein are not actual views of any component, additive manufacturing system, or any component thereof, but are merely idealized representations, which are employed to describe embodiments of the present invention.

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, any relational term, such as “first,” “second,” “top,” “bottom,” “upper,” “lower,” “above,” “beneath,” “side,” “upward,” “downward,” etc., is used for clarity and convenience in understanding the disclosure and accompanying drawings, and does not connote or depend on any specific preference or order, except where the context clearly indicates otherwise. For example, these terms may refer to an orientation of elements of any additive manufacturing device or three-dimensional structure when utilized in a conventional manner.

As used herein, the term “substantially” in reference to a given parameter, property, or condition means and includes to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.). For example, “about” or “approximately” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, the terms “precursor material,” “feed material,” and “feedstock” mean and include a solid material that is not yet at a desired densified (e.g., sintered) state. The precursor material, feed material, or feedstock may be in an unsintered state or in a partially sintered state. The precursor material, feed material, or feedstock may comprise a loose (e.g., flowable) solid powder, solid particles, solid flakes, or other solid masses of small size, such as metal powders or ceramic powders. The precursor material, feed material, or feedstock may have previously been subjected to sintering (e.g., partial sintering) without yet having formed a sintered article exhibiting a desired density. The precursor material, feed material, or feedstock may include one or more of a metal, a ceramic, a composite, a polymer, or mixtures thereof. The precursor material, feed material, or feedstock may be an industrially relevant material, such as a byproduct or waste product of an industrial chemical process. The precursor material, feed material, or feedstock may, for example, include an oxidized metal material produced by unwanted reactions during the industrial chemical process or may include an oxidized metal structure. The precursor material, feed material, or feedstock may also be contained within a solution, suspension, paste, or the like.

As used herein, the term “non-stoichiometric” means and includes a chemical compound (e.g., a metal oxide) with an elemental composition that cannot be represented by a ratio of well-defined natural numbers and is in violation of the law of definite proportions.

A method of forming a three-dimensional structure includes providing a precursor material comprising one or more of a metal oxide, a metal sub-oxide, a metal carbide, a metal nitride, a metal boride, a metal hydride, a metal silicide, a metal salt, and a pre-ceramic polymer. One or more layers of the precursor material is formed (e.g., printed) on a substrate using an additive manufacturing process. The one or more layers may be formed under reducing conditions. Forming the one or more layers under reducing conditions may include forming the one or more layers in a reducing atmosphere. Forming the one or more layers under reducing conditions may also include providing the precursor material as a mixture including one or more precursor materials and one or more reducing agents. The mixture may be printed in a reducing atmosphere or in an inert atmosphere. The mixture may be printed in a mixture of one or more reducing gases and one or more inert gases. The layers of precursor material are exposed to an energy source to react the precursor material to form a three-dimensional structure comprising an elemental metal, a metal alloy, a ceramic, or a composite.

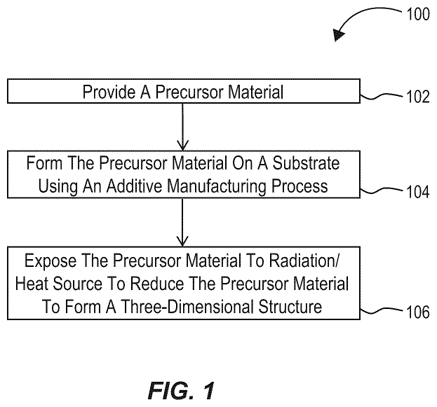

With reference to FIG. 1, a method 100 of forming a three-dimensional structure from a feedstock by an additive manufacturing process is disclosed. The method includes forming a three-dimensional structure (e.g., by three-dimensional printing) and chemically reacting precursor materials in one process (e.g., an in situ method). The method 100 includes providing 102 a precursor material of the three-dimensional structure, where a feedstock may function as a source of the precursor material. The precursor material may be a conductive material or a non-conductive material. Alternately, a portion of the precursor material may be a conductive material. The precursor material is formed (e.g., printed) 104 on a substrate using an additive manufacturing process. A layer of the precursor material may be printed under reducing conditions (e.g., in a reducing atmosphere, in the presence of a reducing agent). In embodiments, the layer of the precursor material may be printed under reducing conditions at an elevated temperature. Additional layers may be formed on the initial layer repeatedly until the three-dimensional structure of desired dimensions is formed. A temperature at which the precursor material is formed on the substrate may be selected based on the thermodynamics of the reaction (e.g., based on the precursor material to be printed). The printing temperature may be, for example, from about 0° C. to about 3000° C., from about 500° C. to about 2500° C., from about 600° C. to about 2000° C., or from about 700° C. to about 1500° C. The reducing conditions may include one or both of forming the precursor material on the substrate in a reducing atmosphere and forming the precursor material on the substrate in the presence of one or more reducing agents. For example, a metal oxide precursor material may be printed in a reducing atmosphere at an elevated temperature to form one or more layers of a non-stoichiometric metal oxide. The elevated temperature may be selected depending on the precursor material. The printed precursor material (e.g., printed metal oxide) is exposed 106 to radiation (e.g., a light source) to react the printed precursor material to form the three-dimensional structure. The resulting three-dimensional structure may be formed of and include a metal material (e.g., elemental metal material), a metal alloy material, a ceramic material, or a composite material, such as a composite material comprising a metallic material and a non-metallic material.

The method 100 comprises a so-called “one step process” where the precursor material is printed and reacted (e.g., reduced) in situ to form the three-dimensional structure from the precursor material (e.g., feedstock). The three-dimensional structure is, therefore, directly formed by the additive manufacturing process.

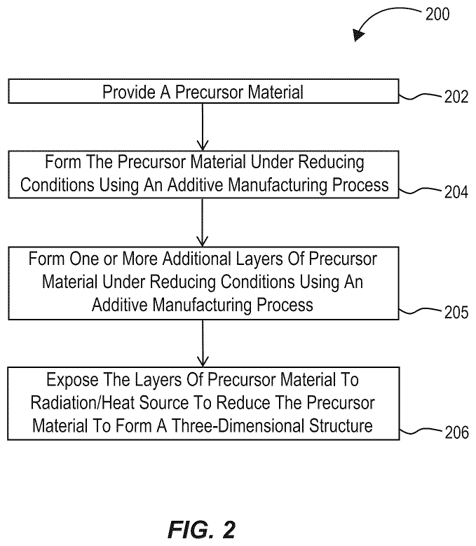

With reference to FIG. 2, another method 200 of forming a three-dimensional structure from a precursor material (e.g., feedstock) by an additive manufacturing process is disclosed. The method 200 includes providing 202 a precursor material of the three-dimensional structure, where the feedstock functions as a source of the precursor material. Providing 202 the precursor material may comprise providing any of the precursor materials described herein. The method includes forming 204 (e.g., printing) the precursor material on a substrate under reducing conditions using an additive manufacturing process. In embodiments, the precursor material may be printed at an elevated temperature. The method includes and forming 205 one or more additional layers of the precursor material under reducing conditions until the three-dimensional structure of desired dimensions is formed. The layers of printed precursor material are exposed 206 to radiation/heat source to react the printed precursor material to form the three-dimensional structure.

The methods according to embodiments of the disclosure enable the in situ formation of the three-dimensional structures using a combination of advanced manufacturing processes and chemical reaction processes. By forming the precursor material on the substrate by advanced manufacturing and substantially simultaneously reacting the precursor material, the three-dimensional structures are formed in situ. In embodiments of the disclosure, the three-dimensional structures are formed in situ by selecting the precursor material to exhibit a quick reaction rate under the reducing conditions and at the reaction temperature.

With reference to methods 100, 200, the feedstock (e.g., precursor material) may include a chemically stable feedstock, increasing the ability to store the feedstock while maintaining its functionality. Using chemically stable feedstocks, such as metal oxides, metal sub-oxides, metal carbides, metal silicides, ceramic oxides, or other stable chemical precursors (e.g., metal salts, pre-ceramic polymers), provide an advantage over conventional metal feedstocks used in conventional processes. Conventional metal feedstocks have a limited shelf-life because of their sensitivity towards oxygen/moistened air. In embodiments of the disclosure, the precursor material includes one or more of a metal oxide, a metal sub-oxide, a metal salt, and a pre-ceramic polymer. The precursor material comprising one or more of a metal oxide, a metal sub-oxide, a metal salt, a metal carbide, a metal nitride, a metal boride, a metal hydride, a metal silicide, and a pre-ceramic polymer provides advantages including, but not limited to, casier material handling, processing, and storage of large volumes of feedstock material as compared to conventional metal feedstocks. Further, the chemically stable feedstock (e.g., metal oxide feedstock) is less expensive compared to conventional metal feedstocks. In embodiments of the disclosure, the precursor material is a metal material, such as a metal oxide material, or a ceramic material.

The precursor material may include a combination of one or more precursor materials. For example, a precursor material may comprise a metal oxide or a combination of metal oxides, a metal salt or a combination of metal salts, a metal carbide or a combination of metal carbides, a metal nitride or a combination of metal nitrides, a metal boride or a combination of metal borides, a metal hydride or a combination of metal hydrides, a metal silicide or a combination of metal silicides, a metalloid or a combination of metalloids, or a pre-ceramic polymer or a combination of pre-ceramic polymers. By way of example only, the metal of the metal oxide or of the metal salt may comprise one or more of aluminum, scandium, titanium, vanadium, chromium, manganese, iron, cobalt, nickel, copper, zinc, zirconium, niobium, molybdenum, cadmium, hafnium, tantalum, tungsten, rhenium, lanthanum, prascodymium, neodymium, gadolinium, samarium, terbium, and dysprosium. The metalloid may be, for example, one or more of boron, silicon, germanium, arsenic, antimony, and tellurium. The precursor material may be a stoichiometric metal compound or a non-stoichiometric metal compound. If the precursor material is a stoichiometric metal compound, the metal compound has a chemical formula of MₓO_{y}, wherein M represents a metal, O represents oxygen, and x and y are integers. If the precursor material is a non-stoichiometric metal compound, the metal compound has a chemical formula of MₓO_{y}, wherein M represents a metal and x and y are non-integer rational numbers. In some embodiments, the precursor material is a non-stoichiometric metal oxide that has less than a stoichiometric amount of oxygen. In some such embodiments, the non-stoichiometric metal oxide comprises an oxygen deficient (e.g., oxygen poor) metal oxide. Using a non-stoichiometric metal feedstock or a metal sub-oxide feedstock may improve the reducibility (e.g., chemical reducibility) of the process. In some embodiments, the precursor material is a stoichiometric metal oxide that is printed under reducing conditions, such as in a reducing atmosphere, to form one or more layers of non-stoichiometric metal oxide in situ. In other embodiments, the reducing conditions may include providing the precursor material in a mixture including one or more reducing agents.

In some embodiments, the precursor material consists essentially of the metal oxide or the combination of metal oxides. The metal oxide may include one or more of a transition metal oxide (e.g., an oxide of one or more of scandium, titanium, vanadium, chromium, manganese, iron, cobalt, nickel, copper, zinc, zirconium, niobium, molybdenum, cadmium, hafnium, tantalum, tungsten, rhenium), one or more of a rare earth metal oxide (e.g., an oxide of one or more of lanthanum, praseodymium, neodymium, gadolinium, samarium, terbium, dysprosium), or a combination thereof. By way of non-limiting example, the precursor material may comprise one or more of aluminum oxide (e.g., Al₂O₃), tantalum oxide (e.g., tantalum pentoxide, Ta₂O₅), niobium oxide (e.g., niobium dioxide, NbO₂, niobium pentoxide, Nb₂O₅), silicon dioxide (SiO₂), titanium oxide (e.g., titanium dioxide, TiO₂, titanium monoxide, TiO₂₋ₓ (a non-stoichiometric oxide)), tungsten oxide (e.g., tungsten trioxide WO₃), and iron oxide (e.g., Fe₂O₃).

The precursor material may, alternately, include a pre-ceramic polymer. The pre-ceramic polymer may include one or more polymeric compounds that, through pyrolysis under appropriate conditions (generally in the absence of oxygen), are converted to ceramic compounds having high thermal and chemical stability. The ceramics resulting from the pyrolysis of pre-ceramic polymers are known as polymer derived ceramics (PDCs). Polymer derived ceramics may be silicon based, such as silicon carbide, silicon oxycarbide, silicon nitride, and silicon oxynitride. The polymer derived ceramics may also be aluminum based, such as one or more of aluminum oxynitride, aluminum nitride, and mixtures of aluminum nitride, aluminum carbide, and aluminum oxide.

In some embodiments, the precursor material is provided as a mixture of one or more precursor materials and one or more reducing agents. The mixture may be printed in a reducing environment or alternately may be printed in a non-reducing environment. The one or more reducing agents may be selected based on the desired product (e.g., three-dimensional structure comprising a metal, a metal alloy, a cermet, an aggregate, etc.). For example, cermets and oxide dispersed solids may be produced by controlling one or more of the type of reducing agent, the amount of reducing agent, and adding unreactive phases (e.g., precursor materials that will not react with the reducing agent). By way of example only, the reducing agent may include one or more of hydrogen, carbon monoxide, ammonia, carbon, silicon, calcium, lithium, sodium, magnesium, aluminum, lanthanum, and mixtures thereof.

The precursor material may be provided in the form of particles. The precursor material may exhibit a particle size (e.g., volume average particle diameter) of, for example, from about 1 micrometer (μm) to about 10 μm, from about 10 micrometers μm to about 500 μm, or from about 100 μm to about 200 μm. The desired particle size of the precursor material may be prepared for the additive manufacturing process by various particle preparation acts, such as one or more of crushing, milling, sieving, washing, drying, dehydrating, and mixing. The particle preparation acts may be performed under a controlled atmosphere (e.g., under argon, helium, nitrogen, or combinations thereof). Oxygen and moisture concentrations, temperature, and pressure (positive or negative) may be controlled, with the specific conditions depending on the precursor material.

The precursor material (e.g., metal oxide) may be printed on a substrate, under reducing conditions, such as in a reducing atmosphere, to form one or more layers of chemically reduced precursor material. If, for example, the precursor material includes a metal oxide, the metal oxide may be reduced to a non-stoichiometric metal oxide or a non-stoichiometric metal alloy. The reducing atmosphere may be formed of, for example, one or more of hydrogen (H₂) gas, ammonia, helium, carbon monoxide (CO), and argon. Reducing gases may be supplied from a source container, such as bottles, cylinders, dewars, and the like. The reducing atmosphere may comprise one or more of ammonia, hydrogen gas, and carbon monoxide. H₂ gas or CO gas may account for substantially all (e.g., about 100%) of the reducing atmosphere or may account for a portion of the reducing atmosphere, such as between about 50% and about 80% of the reducing atmosphere. The balance of the reducing atmosphere may be an inert gas, such as argon or helium.

The H₂ gas or CO may be obtained from an electrolytic cell that is configured, for example, to generate oxygen (O₂) and carbon monoxide (CO) from carbon dioxide (CO₂) and the precursor material may be printed in the reducing atmosphere using CO generated from the electrolytic cell. Alternately, the precursor material may be printed in a reducing atmosphere including H₂ generated from a hybrid system (e.g., a nuclear reactor). By using CO as the reducing atmosphere, a greenhouse gas may be used as the source of the reducing atmosphere, which improves the environmental impacts of the process according to embodiments of the disclosure. The H₂ gas or CO may be obtained from a source container, such as bottles, cylinders, or dewars of the H₂ gas or CO. In situations where formation of hydrides is a concern, the H₂ partial pressure may be controlled to achieve reduction of the precursor material with minimal or substantially no hydride formation. Subsequent dehydriding operations (e.g., using pyrovacuum conditions) may be employed, if necessary. The precursor material (e.g., metal oxide) may also be printed on a substrate in an inert atmosphere.

The precursor material may be printed using an additive manufacturing process. The additive manufacturing process may include one or more of laser printing, laser engineered net shaping, selective laser sintering, metal laser sintering, selective laser melting, electron beam printing, plasma jet printing, powder bed additive manufacturing, wire arc additive manufacturing, direct energy deposition, stercolithography, digital light projection (e.g., digital light processing), sol-gel additive manufacturing, polymer extrusion, three-dimensional printing, ink jet printing, and aerosol jet printing.

Additive manufacturing printing devices and methods for printing metals include powder beds, streams of gas-propelled powder jets, or wire for feedstock, lasers and electron beams as the energy sources, and precision automation equipment for digitally directing the energy source, the feedstock, or both, along the material/energy deposition pathways to form the desired shapes, layer by layer.

The process according to embodiments of the disclosure provides for fabricating metal components directly from digital data using a single piece of fully automated equipment and feedstock materials and without the need for additional hard tooling. Benefits of the process according to embodiments of the disclosure include dramatic reductions in cost and lead time, the ability to produce small-lot or so-called “one-of-a-kind” components on demand, and the ability to prototype and produce advanced, high-performance, and more efficient components that cannot be manufactured through conventional methods due to limitations on the fabrication of complex geometries, materials used, unique microstructure, and improved properties. The process according to embodiments of the disclosure provides metal additive manufacturing (e.g., 3D printing) that may be desired for use in industry, R&D institutions, and government organizations.

After the printing, the method includes exposing layers of printed precursor material to radiation/heat source. Laser systems may be used for the process, where the laser comprises a single or multiple lasers. The laser may be, for example, a neodymium-doped yttrium aluminum garnet (Nd: YAG) laser, a gas laser (e.g., a CO₂ laser) or other laser as known in the art. Laser power may be selected depending on the precursor material, the layer thickness, among other factors. For example, the precursor material may be a powder that is printed as a layer at any desired thickness, such as at a thickness of from about 100 μm to about 500 μm, or from about 200 μm to about 400 μm, and the laser power may be selected based on the layer thickness. By way of example only, the laser power may be from about 200 Watts (W) to about 1500 W, or from about 300 W to about 1000 W. The laser spot size may be, for example, from about 50 μm to about 1 millimeter (mm). Parameters such as laser pulse time, scan speed, scan path, and scan gap may be selected depending on the precursor material, the layer thickness, among other factors. Pulse time may be adjusted depending on the interaction of the laser light (e.g., reflectance, scattering, and absorbance), desired temperature, and the thermal and optical properties of the precursor materials under irradiation/heating. One of the multiple lasers may be used to preheat the printing area to control local temperature. Build chamber and print bed temperature may be controlled to minimize thermal gradients of the fabricated three-dimensional structure during the printing process. Scan gap will depend on the spot size of the laser and the desired overlap of irradiation.

For electron beam (e-beam) powder bed printing, a conductive precursor material, or a precursor material mixture where at least a portion of the precursor material mixture is conductive, may be used. The parameters used for printing with lasers may also be used for printing with e-beam systems (e.g., chamber/build plate temperature, atmosphere conditions, and scan speed). Electron beam power is controlled by the accelerating voltage (e.g., 20-60 kV) and current (e.g., up to 150 mA) of the electron gun depending on the power requirements (e.g., 500-2500 W).

Ink jet printing precursor materials may include the same precursor materials as used in laser or e-beam printing, including, not limited to, metals, ceramics, composites, or polymers. The precursor materials may be contained within solutions, suspensions, or pastes, and may be prepared by mixing, blending, heating, and selecting an appropriate carrier liquid, according to methods known in the art. During the ink jet printing process, the printhead expels droplets in a temperature range of from about room temperature (e.g., from about 20° C. to about 25° C.) to about 70° C., at a controlled speed, with ink droplets being in the sub-femtoliter to picoliter size range, through nozzles. The solution feed rate, nozzle size, and multiple nozzle print heads may be adjusted to achieve feature sizes (e.g., portions of the printed layers) of any suitable or desired size, such as from about 100 nanometers (nm) to about 1 mm. Multiple nozzle print heads may be used to combine reactants (e.g., the precursor material) at the print surface. Light exposure may be used for curing or activation (prior to heating via laser or e-beam), and the ink viscosity typically falls in the range of from about 1 centipoise (cP) to about 20 cP, with functional material (e.g., precursor material) loading concentrations between from about 5 weight percent to about 70 weight percent.

Aerosol jet printing precursor materials may use the same or similar precursor materials as those described above and may be prepared in a similar manner. During aerosol jet printing, a liquid ink containing functional materials (e.g., precursor materials) is atomized to produce droplets having a size of from about 1 μm to about 5 μm. The printhead expels the atomized droplets through the printhead nozzle(s). As with ink jet printing, aerosol jet printing may employ multiple nozzle print heads to combine reactants at the print surface, enabling the deposition of features ranging, for example, of from about 1 μm to about 1 mm. Aerosol printing temperatures may be, for example, from about 5° C. to about 50° C. The ink viscosity may vary widely and may be, for example, from about 1 cP to about 10000 cP, accommodating a broad range of functional material loading concentrations (e.g., from about 5 weight percent to about 90 weight percent).

Both ink jet and aerosol jet printing provide flexibility of material deposition, may be employed for diverse applications, and may include post-processing acts, such as acts to isolate the functional material after deposition. While deposition of ink and aerosol media occurs at relatively lower temperatures, the chemical reaction to react the precursor material to form the three-dimensional structure may be performed by a laser or e-beam after deposition of the layer by ink jet or aerosol jet printing. This approach may utilize a printhead that integrates the ink or aerosol nozzle with the directed energy source (e.g., laser). Ink or aerosol deposition and irradiation may be performed in the same pass, or deposition of an entire layer of material may be performed first, followed by exposure of the deposited layer to radiation.

The method may be carried out using a system for additively manufacturing the three-dimensional structure. An additive manufacturing system may comprise, for example, a laser engineering system, a selective laser sintering system, or other system for additively manufacturing a structure (e.g., three-dimensional metal structure). The system for additively manufacturing a structure may be as described in U.S. Pat. No. 11,919,078, which is hereby incorporated by reference herein in its entirety. The system may comprise a table configured to receive a substrate upon which the three-dimensional structure is to be formed. The table may be configured to move in the x-direction and the y-direction, and, optionally, the table may be configured to move in the z-direction. The substrate may comprise any suitable material on which the three-dimensional structure may be formed by additive manufacturing.

The three-dimensional structure may be formed (e.g., printed) over the substrate by disposing the precursor material (e.g., a powder material) on the substrate, and exposing the precursor material to energy from an energy source (e.g., a light source). The light source may comprise one or more of an ultraviolet light, a solid-state laser, an electron beam laser, a free-electron laser, a chemical laser, and a gas laser. In embodiments, the light source comprises a laser. The precursor material may be provided to a surface of the substrate via one or more delivery nozzles (e.g., powder delivery nozzles) of the additive manufacturing system. In some embodiments, more than one powder delivery nozzle is provided, wherein at least one of the powder delivery nozzles is configured to provide a powder (e.g., precursor material) having a different composition than the powder provided by at least another powder delivery nozzle. In some embodiments, powder from different powder delivery nozzles may converge on the substrate or on a previously deposited portion of the structure.

The powder material may comprise one or more of the precursor materials and/or one or more of the reducing agents described above. Accordingly, the powder material may include one or more metal oxides, metal sub-oxides, metalloids, metal salts, pre-ceramic polymers, and, optionally, one or more reducing agents.

Another system for additively manufacturing a three-dimensional structure in accordance with embodiments of the disclosure comprises a tank (e.g., a vessel) including a feed material (e.g., precursor material) therein. The tank may include an inlet through which a gas is introduced to atomize the feed material and form an aerosol. The aerosol may be provided to a delivery nozzle (e.g., a deposition head) via an outlet of the tank. A sheath gas (e.g., carrier gas) may be mixed with the aerosol as the aerosol exits the delivery nozzle. The sheath gas may be provided via a sheath gas outlet, which may comprise a shroud around the outlet of the delivery nozzle. A beam of the aerosol may be provided to a surface of the substrate or an upper surface of an article to form a thickness (e.g., a layer) of the three-dimensional structure.

After depositing the aerosol on the substrate and forming a thickness of the three-dimensional structure, the delivery nozzle may be moved relative to the substrate. The aerosol may be delivered to the upper exposed surface of the structure to form another thickness of the structure. The process may be repeated until the three-dimensional structure is formed to have a desired size and shape.

The feed material may include one or more of the precursor materials and/or one or more of the reducing agents described above. Accordingly, the feed material may include one or more metal oxides, metal sub-oxides, metal salts, metal carbides, metal silicides, metal hydrides, metal nitrides, metal borides, metalloids, pre-ceramic polymers, and, optionally, one or more reducing agents.

The systems for additively manufacturing (e.g., printing) the three-dimensional structure may be controlled by a processor having associated therewith a memory including instructions configured to direct the respective ones of the powder delivery nozzles and the delivery nozzle to locations where powder or the aerosol from the respective powder delivery nozzle or delivery nozzle is provided. By way of nonlimiting example, the memory may include data for formation of a desired structure in the form of a computer-aided-design (CAD) model or a computer-aided-manufacturing (CAM) model configured to direct the powder delivery nozzles and the delivery nozzle.

A printing process including the acts of sintering and melting may be selected for carrying out in situ chemical reactions and producing a three-dimensional structure in accordance with embodiments of the disclosure. Laser and electron (e-beam) processes may be used to produce the three-dimensional structure having varying densities and mechanical properties (e.g., compressive strength, surface roughness, strength). The method of forming a three-dimensional structure may be utilized with any additive manufacturing system and is not limited to the above-described additive manufacturing systems. For example, one or more three-dimensional structures may be additively manufactured in accordance with the process disclosed herein utilizing other systems, such as a selective laser sintering (SLS) system, a powder bed additive manufacturing system, a wire arc additive manufacturing system, a plasma jet printing system, direct energy deposition, stereolithography, digital light projection (e.g., digital light processing), solgel additive manufacturing, another additive manufacturing method, or combinations thereof.

Forming the three-dimensional structure may include, for example, forming at least a first thickness of a material (e.g., the precursor material) on a surface of a substrate and forming additional layers of the material of the three-dimensional structure on previously formed surfaces until a three-dimensional structure having a desired size and shape is formed. Forming the first thickness of the three-dimensional structure may include forming a first thickness of a precursor material (e.g., powder mixture, feed material) on a surface of the substrate and exposing (e.g., selectively exposing) at least a portion of the first thickness of the feed material to energy (e.g., a light source, electromagnetic radiation from a laser, energy from an electron beam, a plasma beam) to form bonds (e.g., metallurgical bonds, such as by sintering) between adjacent particles of the feed material within the first thickness. In some embodiments, a portion of the first thickness of the feed material is not exposed to the energy such that the unexposed portion of the feed material does not form bonds with adjacent particles of the precursor material. In some such embodiments, only a portion of the first thickness of the precursor material is selectively exposed to the light source. As used herein, selectively exposing a material to energy (e.g., light source) means and includes exposing only a portion of the material (e.g., a particular pattern of the material) to the energy. The energy may include, for example, focused energy, such as a laser, an electron beam, heat through a nozzle, a plasma, or another form of focused energy (e.g., a beam). The structure may be formed layer by layer to form the final three-dimensional structure having the desired size and shape. Accordingly, after forming the first layer of the structure, additional layers of the structure may be formed over previously formed layers of the structure until the three-dimensional structure having a desired size and shape is formed.

In embodiments of the discourse, the process includes printing the precursor material in a reducing atmosphere. Depending on the degree of chemical reduction to be achieved, the reducing atmosphere may include an excess of the reducing agent or the reducing gas or a stoichiometric amount of the reducing agent or the reducing gas. If partial chemical reduction is desired, a lower relative amount of the reducing agent or the reducing gas may be used. The printing may be performed in an additive manufacturing system having an enclosure disposed around the energy (e.g., light) source, the table, the substrate, the three-dimensional structure, the aerosol, the delivery nozzle, and the beam. The enclosure may include an inlet and an outlet configured to facilitate introduction of a reducing gas (e.g., one or more of the reducing gases described above, such as one or more of hydrogen, carbon monoxide, a mixture of hydrogen and helium, a mixture of hydrogen and argon) into a volume within the enclosure. In use and operation, the reducing gas may flow through the enclosure during additive manufacturing of the three-dimensional structure. The reducing gas may be produced by a secondary process, such as by one or more of an electrolytic cell and a nuclear reactor, and the so-produced reducing gas may be utilized as the reducing atmosphere in the process of forming the three-dimensional structure. Therefore, the methods according to embodiments of the disclosure may use reaction products, byproducts, or waste products of other chemical processes to form the three-dimensional structure.

Exposing the printed precursor material to radiation (e.g., the light source) to form a three-dimensional structure includes forming a three-dimensional structure comprising one or more of a metal, a metal alloy, an intermetallic compound, a cermet, an aggregate, an oxide dispersed metal, a functionally graded material, a diffusion bonded layered material, a material exhibiting a metal-ceramic interface, a material exhibiting a hierarchical structure, a high entropy alloy, and a high temperature alloy. The three-dimensional structure may comprise one or more of aluminum, aluminum nitride, silicon, silicon carbide, silicon nitride, iron, iron aluminide, tantalum, tantalum carbide, niobium, niobium silicide, titanium, titanium carbide, titanium disilicide, molybdenum, molybdenum disilicide, tungsten, tungsten carbide, tungsten disilicide, uranium, lanthanum chromite, yttrium carbide, lanthanum phosphate, yttrium carbide or mixtures thereof.

In embodiments of the disclosure, metals and metal alloys may be directly fabricated from an oxide feedstock (e.g., a single metal oxide or a combination of metal oxides) utilizing an additive manufacturing printing process. The process enables in situ transformation of the oxide body to its metal constituent(s). A reducing agent may be used with a metal oxide feedstock during the additive manufacturing printing process. By way of example only, exposing the printed precursor material to a light source to form a three-dimensional structure proceeds according to one or more of the following reactions with exemplary temperatures in parentheses:

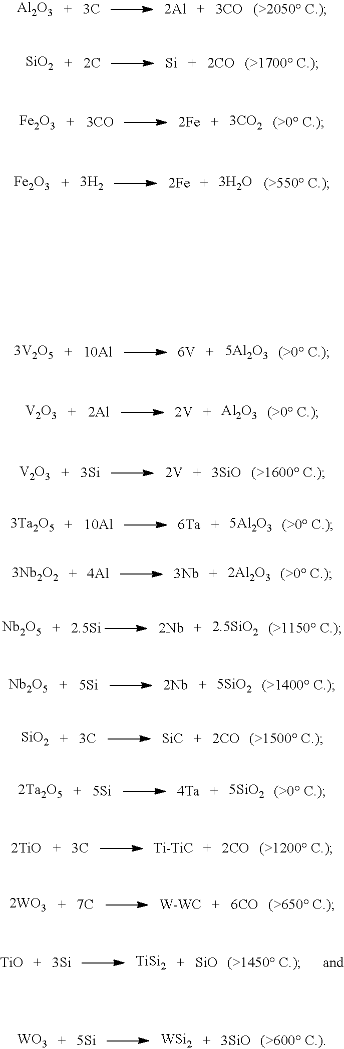

The method may optionally further include conducting one or more post-printing acts. For example, the method may comprise performing one or more secondary processes on the resulting three-dimensional structure, such as one or more of heat treatment, annealing, cleaning, surface finishing, machining, polishing, precipitation, phase separation, chemical treatment, and drying.

Properties, such as crystalline structure, grain boundaries, density, etc., of the resulting three-dimensional structure may differ from those obtainable with conventional three-dimensional structures.

The three-dimensional structure may be reproducibly formed by the additive manufacturing process. The process enables a high quality, three-dimensional structure to be formed with structural integrity. The formed three-dimensional structure may be suitable for use in highly regulated industries, such as nuclear, biomedical, microwave engineering, and transportation industries. The process can be deployed to manufacture components, tailored with unique properties, that are difficult or impossible to achieve by conventional manufacturing methods. Since an additive manufacturing process is used, the three-dimensional structure may be formed to a near-net-shape. The methods according to embodiments of the disclosure may provide increased process control, improved surface finishing of the three-dimensional structure, and increased throughput of the three-dimensional structure.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

What is claimed is:

1. A method of forming a three-dimensional structure, the method comprising:
forming a layer of a precursor material on a substrate using an additive manufacturing process, the precursor material comprising one or more of a metal oxide, a metal sub-oxide, a metal carbide, a metal nitride, a metal boride, a metal hydride, a metal silicide, a metalloid, a metal salt, and a pre-ceramic polymer;
forming one or more additional layers of the precursor material on the layer of the precursor material; and
exposing the layers of precursor material to an energy source to reduce the precursor material to form a three-dimensional structure comprising an elemental metal, a metal alloy, a ceramic, or a composite.

2. The method of claim 1, wherein forming a layer of a precursor material and forming one or more additional layers of the precursor material on the layer comprises using laser printing, laser engineered net shaping, selective laser sintering, metal laser sintering, selective laser melting, electron beam printing, plasma jet printing, powder bed additive manufacturing, wire arc additive manufacturing, direct energy deposition, stereolithography, digital light projection, sol-gel additive manufacturing, polymer extrusion, ink jet printing, or aerosol jet printing to form the layers of the precursor material.

3. The method of claim 1, wherein forming a layer of a precursor material on a substrate comprises forming one or more of a transition metal oxide and a rare earth metal oxide on the substrate.

4. The method of claim 1, wherein forming a layer of a precursor material on a substrate comprises forming a mixture of the precursor material comprising one or more precursor materials and one or more reducing agents.

5. The method of claim 4, wherein forming a mixture of the precursor material comprising one or more precursor materials and one or more reducing agents comprises combining one or more reducing agents comprising hydrogen, carbon monoxide, ammonia, carbon, silicon, calcium, lithium, sodium, magnesium, aluminum, and lanthanum with the precursor material.

6. The method of claim 1, wherein forming a layer of a precursor material on a substrate comprises forming the layer consisting essentially of a metal oxide or consisting essentially of a combination of metal oxides.

7. The method of claim 1, further comprising forming the layer of precursor material under reducing conditions, the reducing conditions comprising forming the layer of the precursor material in a reducing atmosphere or in the presence of a reducing agent.

8. The method of claim 7, wherein forming the layer of the precursor material under a reducing atmosphere comprises introducing one or more of ammonia, hydrogen gas, and carbon monoxide while forming the layer of the precursor material.

9. The method of claim 8, wherein introducing one or more of ammonia, hydrogen gas, and carbon monoxide while forming the layer of the precursor material comprises providing one or more of hydrogen gas and carbon monoxide produced by one or more of an electrolytic cell and a nuclear reactor.

10. The method of claim 1, wherein exposing the layers of precursor material to an energy source to reduce the precursor material comprises exposing the layers of precursor material to one or more of an ultraviolet light, a solid-state laser, an electron beam laser, a free-electron laser, a chemical laser, and a gas laser.

11. The method of claim 1, wherein exposing the layers of precursor material to an energy source to reduce the precursor material comprises forming a three-dimensional structure comprising one or more of a metal, a metal alloy, an intermetallic compound, a cermet, an aggregate, an oxide dispersed metal, a functionally graded material, a diffusion bonded layered material, a material exhibiting a metal-ceramic interface, a material exhibiting a hierarchical structure, a high entropy alloy, and a high temperature alloy.

12. The method of claim 1, wherein exposing the layers of precursor material to an energy source to reduce the precursor material comprises forming a three-dimensional structure comprising one or more of aluminum, aluminum nitride, silicon, silicon carbide, silicon nitride, iron, iron aluminide, tantalum, tantalum carbide, niobium, niobium silicide, titanium, titanium carbide, titanium disilicide, molybdenum, molybdenum disilicide, tungsten, tungsten carbide, tungsten disilicide, uranium, lanthanum chromite, yttrium carbide, lanthanum phosphate, and yttrium carbide.

13. The method of claim 1, wherein exposing the layers of precursor material to an energy source to reduce the precursor material comprises one or more of the following reactions:

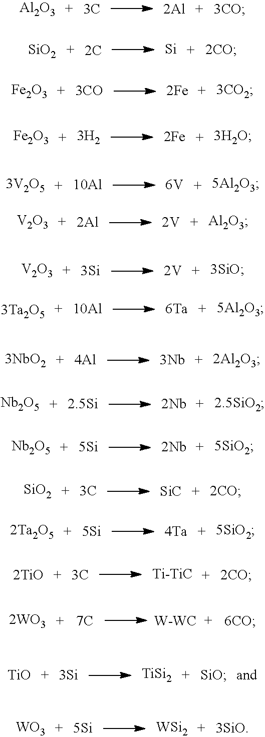

14. The method of claim 1, further comprising:
performing one or more of heat treating, annealing, cleaning, surface finishing, machining, polishing, precipitating, phase separating, chemical treatment, and drying to the three-dimensional structure.

15. A method of forming a three-dimensional structure, the method comprising:
forming a layer of the precursor material on a substrate using an additive manufacturing process the precursor material comprising one or more of a metal oxide, a metal sub-oxide, a metal carbide, a metal nitride, a metal boride, a metal hydride, a metal silicide, a metalloid, a metal salt, and a pre-ceramic polymer and one or more reducing agents;
forming one or more additional layers of the precursor material on the layer of the precursor material; and
exposing the layers of precursor material to an energy source to reduce the precursor material to form a three-dimensional structure comprising an elemental metal, a metal alloy, or a ceramic.

16. The method of claim 15, wherein providing a precursor material comprising one or more of a metal oxide, a metal sub-oxide, a metal carbide, a metal nitride, a metal boride, a metal hydride, a metal silicide, a metalloid, a metal salt, and a pre-ceramic polymer and one or more reducing agent comprises providing the precursor material and one or more of aluminum oxide, tantalum oxide, niobium oxide, silicon dioxide, titanium oxide, tungsten oxide, and iron oxide.

17. The method of claim 15, wherein forming a layer of the precursor material on a substrate using an additive manufacturing process and forming one or more additional layers of the precursor material on the layer of the precursor material comprises forming the layers in a mixture comprising one or more reducing gases and one or more inert gases.

18. A method of forming a three-dimensional structure, the method comprising:
forming one or more layers of a stoichiometric metal oxide on a substrate under reducing conditions using an additive manufacturing process to form one or more layers of a non-stoichiometric metal oxide on the substrate; and
exposing the one or more layers of the non-stoichiometric metal oxide to an energy source to reduce the non-stoichiometric metal oxide to form a three-dimensional structure comprising an elemental metal or a metal alloy.

19. The method of claim 18, wherein forming one or more layers of a stoichiometric metal oxide on a substrate under reducing conditions comprises forming the one or more layers of the stoichiometric metal oxide on the substrate in a reducing atmosphere comprising one or more of hydrogen gas, ammonia, helium, and carbon monoxide.

20. The method of claim 18, wherein exposing the one or more layers of the non-stoichiometric metal oxide to an energy source to reduce the non-stoichiometric metal oxide to form a three-dimensional structure comprises selective laser sintering the one or more layers of non-stoichiometric metal oxide to form a three-dimensional structure comprising the elemental metal, the metal alloy, or the composite.
